(19) United States
(12) Patent Application Publication
(10) Pub. No.: US 2007/0053039 A1
(43) Pub. Date: Mar. 8, 2007

(54) Multi-station laser processing

(76) Inventor: Wolfgang Andreasch, Weinstadt (DE)

Correspondence Address: FISH & RICHARDSON PC, P.O. BOX 1022, MINNEAPOLIS, MN, 55440-1022, US

(21) Appl. No.: 11/363,516

(22) Filed: Feb. 24, 2006

(30) Foreign Application Priority Data
Feb. 25, 2005 (EP) EP 05 004 168

(51) Int. Cl. G02B 26/08

(52) U.S. Cl. 359/204

(57) ABSTRACT

A laser processing machine includes several workstations for one workpiece each, a laser for generating a laser beam, and a laser beam deflecting device. The deflecting device includes a rotatably disposed deflecting mirror for deflecting the laser beam in the direction of several workstations through turning the deflecting mirror about an axis of rotation.

### CROSS-REFERENCE TO RELATED APPLICATIONS

This application claims priority under 35 USC §119(a) from European patent application EP 05 004 168, filed Feb. 25, 2005. The complete disclosure of this priority application is incorporated herein by reference.

### TECHNICAL FIELD

The invention relates to a laser processing machines, such as those configured to work with a plurality of workstations for one workpiece each, using a laser for generating a laser beam, and a laser beam deflecting device.

### BACKGROUND

For some laser processing systems having multiple stations, the complete array of scanner optics is moved from workstation to workstation. Accordingly, each workstation requires one scanner optics and one beam management using beam deflector(s). In both cases, several axes of movement or drives are required. The beam deflector moreover increases the number of deflecting mirrors. DE10252443 A1 discloses a laser beam deflecting device comprising a deflecting mirror which is disposed in such a manner that it can be rotated.

### SUMMARY

This invention features a laser deflecting device with a rotatably disposed deflecting mirror for deflecting a laser beam to multiple workstations by turning the deflecting mirror about its axis of rotation. Thus, a change from one workstation to another workstation may be realized by turning the deflecting mirror about the axis of rotation, i.e., by a highly dynamic axis of movement which can additionally be used for adjusting the mirror(s). This multi-station operation may be realized without an additional axis of movement, and without additional drives or beam deflectors.

In some embodiments, the workstations are disposed opposite to one another, and the workpieces are clamped in a vertical direction. Vertical clamping of the workpieces and opposing working areas are advantageous for the integration in production lines, since they improve the ergonomic conditions during clamping and removing of the workpieces.

For two-dimensional laser processing, the deflecting mirror is preferably disposed in such a manner that it can be pivoted about a first pivot axis lying in its mirror surface, and about a second pivot axis which extends at a right angle to the first pivot axis.

According to one aspect, a laser processing machine includes a laser configured to generate a laser beam along a beam path, a plurality of workstations, each arranged to receive a workpiece, and a beam deflection mirror disposed along the beam path and rotatable about a first axis to sequentially deflect the laser beam toward different ones of the workstations to process selected workpieces.

In some embodiments, the workstations include first and second workstations disposed opposite each other. In some embodiments, the first and second workstations are configured for vertical workpiece mounting. In some cases, the laser and beam deflection mirror are configured to define a conical scanning area for each workstation, across which the laser beam is movable to process an associated workpiece.

In some configurations, the first axis is perpendicular to the beam path incident to the deflection mirror. In some cases, the first axis extends along a surface of the mirror. In some cases, the beam deflection mirror has a substantially planar mirror surface.

In some configurations, the mirror is mounted to a holder pivotably coupled to a mirror driver and to a support at spaced apart, parallel pivots, such that translation of the mirror driver relative to the support along a translation axis perpendicular to the pivots causes rotation of the mirror about the first axis. In some cases, the support is restrained against movement along the translational axis.

In some configurations, the pivot at which the holder is coupled to the mirror driver is coincident with the first axis, such that translation of the mirror driver relative to the support along the translation axis perpendicular to the pivots causes simultaneous rotation of the mirror about the first axis and translation of the first axis. In some cases, the mirror driver and support are together rotatable about the translation axis. In some implementations, the pivot at which the holder is coupled to the support is coincident with the first axis, such that the first axis remains stationary during translation of the mirror driver relative to the support along the translation axis. In some cases, the support is rotatable to rotate the mirror about the translation axis.

According to another aspect, a method of processing multiple workpieces in multiple, separate workstations includes generating a laser beam along a beam path, directing the laser beam to a beam deflection mirror, orienting the beam deflection mirror to direct the laser beam toward a first workstation, engaging a workpiece in the first workstation with the deflected beam to process the workpiece, rotating the beam deflection mirror about a rotation axis to redirect the laser beam toward a second workstation, and engaging a workpiece in the second workstation with the redirected beam to process the workpiece in the second workstation.

In some cases, the method includes first vertically mounting workpieces in the workstations. In some cases, the mirror is pivotally mounted to a mirror driver and to a support at parallel, spaced apart pivots, and wherein rotating the beam deflection mirror comprises translating the mirror driver with respect to the support along a translation axis parallel to the beam path incident to the mirror. In some examples, the first axis is reoriented while rotating the beam deflection mirror by rotating the rotating the mirror driver or rotating the rotating the support, for example.

The details of one or more embodiments of the invention are set forth in the accompanying drawings and the description below. Other features and advantages will be apparent from the description and drawings, and from the claims.

### DESCRIPTION OF DRAWINGS

FIG. 1a shows a perspective view of a laser processing machine prior to laser processing;

FIG. 1b shows a laser processing machine in accordance with FIG. 1a with indicated laser processing areas;

FIG. 2a shows a further view of the laser processing machine prior to laser processing;

FIG. 2b shows a laser processing machine in accordance with FIG. 2a with indicated laser processing areas;

FIG. 3 shows a first feasible embodiment of a laser beam deflecting device of the laser processing machine; and

FIG. 4 shows a second feasible embodiment of the laser beam deflecting device of the laser processing machine.

Like reference symbols in the various drawings indicate like elements.

### DETAILED DESCRIPTION

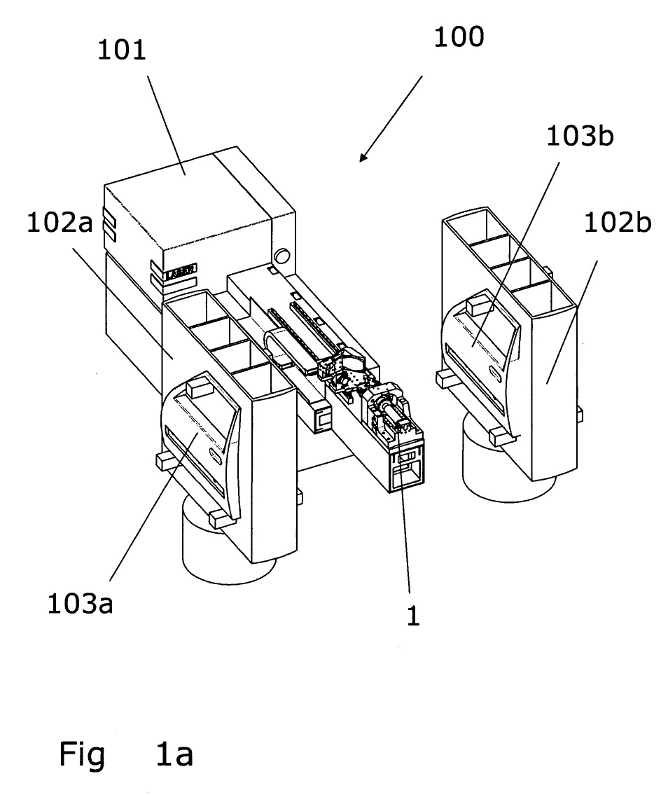

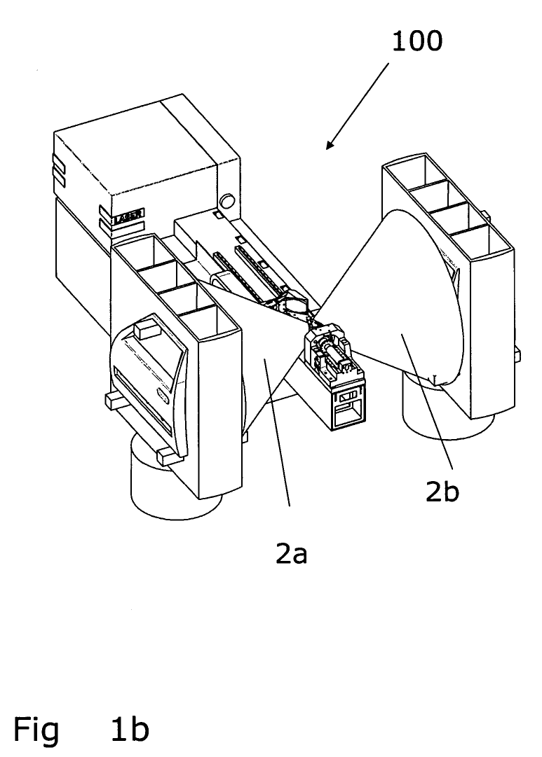

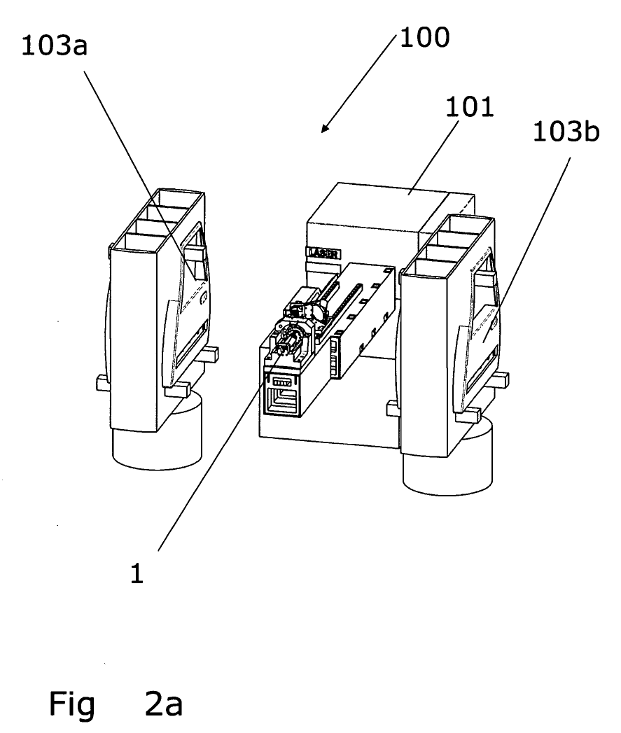

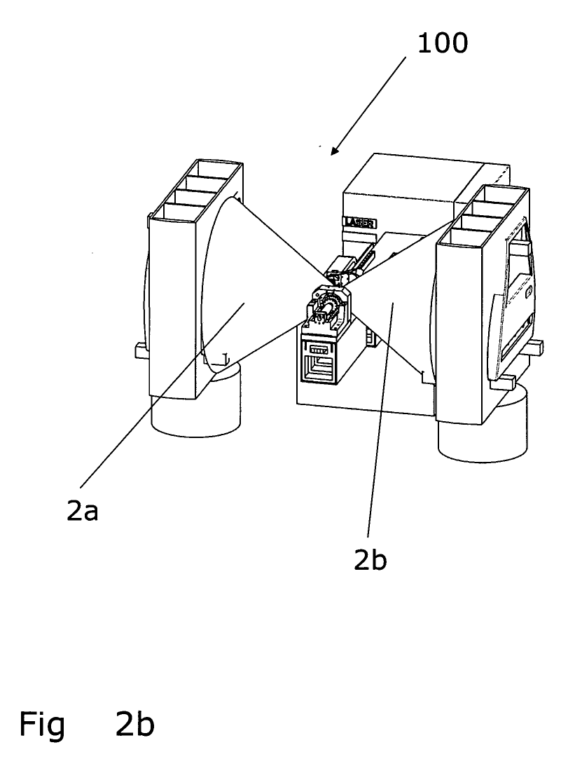

FIGS. 1a, 1b and 2a, 2b schematically show the construction of a laser processing machine 100 which comprises a laser 101 for generating a laser beam, and a laser beam deflecting device 1. The generated laser beam can be deflected by the laser beam deflecting device 1 either within a scanning area 2a or within a scanning area 2b to permit processing of components 103a, 103b which are vertically clamped in workpiece receptacles 102a, 102b. The laser beam deflecting device 1 permits processing of the whole area of the components 103a, 103b which is indicated by the beam cones 2a, 2b (FIGS. 1b, 2b) which represent the scanning areas or laser processing areas. The range of movement of the axes of the laser beam deflecting device 1 includes at least two workstations which are disposed opposite to each other. It is possible to change from one working area to another working area by turning the laser beam deflecting device 1 about an axis of rotation.

It is also feasible to provide three workstations instead of two, and operate the system with three stations. The third working area could be located for example at a right angle or any other angle between the two opposite working areas.

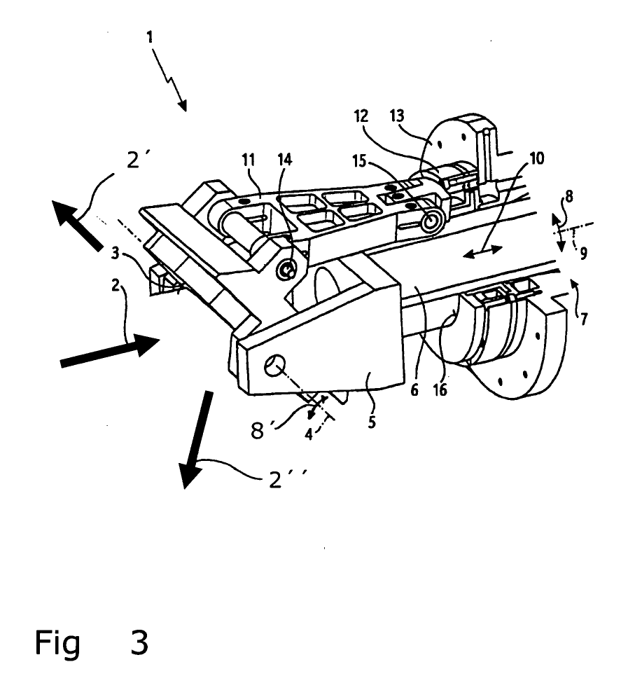

The device 1 shown in FIG. 3 deflects a laser beam 2 (deflection 2′ or 2″ within the scanning areas 2a or 2b) by means of a deflecting mirror 3 which is disposed in a fork-shaped holder 5 such that it can be rotated about a first pivot axis 4 (see double 25 arrow 8′). The holder 5 is mounted to the drive element 6 of a rotary thrust drive 7 which can perform, either simultaneously or separately, a rotational motion (double arrow 8) about a second pivot axis 9 extending at a right angle to the first pivot axis 4, and a translatory motion (double arrow 10). This second pivot axis 9 extends collinearly to the optical axis of the laser beam 2 incident on the deflecting device 1. The deflecting mirror 3 is hinged via a support lever 11 to an annular connecting element 12 that is disposed on a housing flange 13 of the rotary thrust drive 7 such that it can be rotated about the second pivot axis 9 but cannot be axially displaced. The lever 11 is disposed on the rear side of the deflecting mirror 3 and on the connecting element 12 in such a manner that it can be rotated about axes 14, 15 each extending parallel to the first pivot axis 4. The drive element 6 extends through the annular opening 16 of the connecting element 12 and to the holder 5 which is disposed between the deflecting mirror 3 and the connecting element 12.

A rotational coupling may advantageously be provided between the drive element 6 and the connecting element 12 which is, however, not shown in FIG. 3.

The holder 5 and hence also the deflecting mirror 3 are pivoted about the second pivot axis 9 by turning the mirror driver or drive element 6. A translatory motion of the drive element 6 along the second pivot axis 9 causes displacement of the holder 5 relative to the connecting element 12. Since the connecting element 12 is disposed in such a manner that it cannot be displaced, the deflecting mirror 3 is pivoted about the first pivot axis 4. The deflecting mirror 3 can be arbitrarily tilted about both pivot axes 4, 9 by simultaneously pivoting and displacing the holder 5 using the drive element 6, thereby deflecting the incident laser beam 2 in two dimensions.

The drive element 6 has a translational and rotational degree of freedom, and can be disposed in rolling, air or magnetic bearings. A tubular linear motor in combination with a torque motor with primary and secondary parts of different lengths may for example be used as rotary thrust drive 7. These two motors are rotary current synchronous motors, permitting stationary arrangement of their heavy copper and iron containing primary coil components.

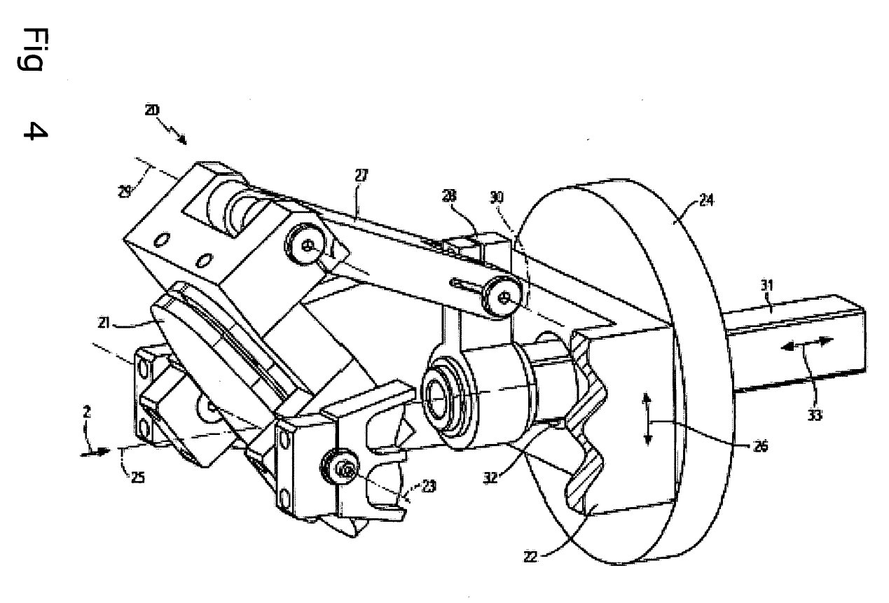

In the deflecting device 20 shown in FIG. 4, the deflecting mirror 21 is also disposed in a fork-shaped holder 22 in such a manner that it can be pivoted about a first pivot axis 23 lying in its mirror surface. The holder or support 22 is disposed in a housing flange 24 such that it can be pivoted about a second pivot axis 25 which extends at a right angle to the first pivot axis 23, but cannot be displaced along the second pivot axis 25. This second pivot axis 25 extends collinearly to the optical axis of the laser beam 2 incident on the deflecting device 20. The holder 22 is turned (double arrow 26) about the second pivot axis 25 using a rotary drive (not shown), for example, using a torque motor according to the principle of a rotary current synchronous motor. The deflecting mirror 21 is hinged via a lever 27 to a connecting element 28 disposed between the deflecting mirror 21 and the holder 22. The lever 27 is disposed on the rear side of the deflecting mirror 21 and on the connecting element 28 in such a manner that it can be rotated about axes 29, 30 each extending parallel to the first pivot axis 23. The drive element 31 of a linear drive (not shown) extends through a central opening 32 of the holder 22 and to the connecting element 28 which is disposed on the free end of the drive element 31 in such a manner that it can be rotated but not be axially displaced. In contrast to the connecting element 12 of the deflecting device 1, the connecting element 28 performs a linear and a rotational motion.

The deflecting mirror 21 is pivoted about the second pivot axis 25 by a pivoting motion of the holder 22 about the second pivot axis 25. Since the holder 22 is disposed in such a manner that it cannot be linearly displaced, a linear motion of the drive element 31 along the second pivot axis 25 (double arrow 33) causes displacement of the connecting element 28 relative to the holder 22, thereby pivoting the deflecting mirror 21 about the first pivot axis 23. The deflecting mirror 21 can be arbitrarily tilted about both pivot axes 23, 25 through simultaneous pivoting of the holder 22 and displacement of the connecting element 28, thereby deflecting the incident laser beam 2 in two dimensions.

A number of embodiments of the invention have been described. Nevertheless, it will be understood that various modifications may be made without departing from the spirit and scope of the invention. Accordingly, other embodiments are within the scope of the following claims.

What is claimed is:

1. A laser processing machine comprising:
a laser configured to generate a laser beam along a beam path;
a plurality of workstations, each arranged to receive a workpiece; and
a beam deflection mirror disposed along the beam path and rotatable about a first axis to sequentially deflect the laser beam toward different ones of the workstations to process selected workpieces.

2. The machine of claim 1 wherein the workstations include first and second workstations disposed opposite each other.

3. The machine of claim 2 wherein the laser and beam deflection mirror are configured to define a conical scanning area for each workstation, across which the laser beam is movable to process an associated workpiece.

4. The machine of claim 2 wherein the first and second workstations are configured for vertical workpiece mounting.

5. The machine of claim 1 wherein the first axis is perpendicular to the beam path incident to the deflection mirror.

6. The machine of claim 4 wherein the first axis extends along a surface of the mirror.

7. The machine of claim 1 wherein the beam deflection mirror has a substantially planar mirror surface.

8. The machine of claim 1 wherein the mirror is mounted to a holder pivotably coupled to a mirror driver and to a support at spaced apart, parallel pivots, such that translation of the mirror driver relative to the support along a translation axis perpendicular to the pivots causes rotation of the mirror about the first axis.

9. The machine of claim 8 wherein the support is restrained against movement along the translational axis.

10. The machine of claim 8 wherein the pivot at which the holder is coupled to the mirror driver is coincident with the first axis, such that translation of the mirror driver relative to the support along the translation axis perpendicular to the pivots causes simultaneous rotation of the mirror about the first axis and translation of the first axis.

11. The machine of claim 10 wherein the mirror driver and support are together rotatable about the translation axis.

12. The machine of claim 8 wherein the pivot at which the holder is coupled to the support is coincident with the first axis, such that the first axis remains stationary during translation of the mirror driver relative to the support along the translation axis.

13. The machine of claim 12 wherein the support is rotatable to rotate the mirror about the translation axis.

14. A method of processing multiple workpieces in multiple, separate workstations with a laser beam, the method comprising
generating a laser beam along a beam path;
directing the laser beam to a beam deflection mirror;
orienting the beam deflection mirror to direct the laser beam toward a first workstation;
engaging a workpiece in the first workstation with the deflected beam to process the workpiece;
rotating the beam deflection mirror about a rotation axis to redirect the laser beam toward a second workstation; and
engaging a workpiece in the second workstation with the redirected beam to process the workpiece in the second workstation.

15. The method of claim 14 including first vertically mounting workpieces in the workstations.

16. The method of claim 14 wherein the mirror is pivotally mounted to a mirror driver and to a support at parallel, spaced apart pivots, and wherein rotating the beam deflection mirror comprises translating the mirror driver with respect to the support along a translation axis parallel to the beam path incident to the mirror.

17. The method of claim 16 wherein the first axis is reoriented while rotating the beam deflection mirror.

18. The method of claim 17 wherein the first axis is reoriented by rotating the rotating the mirror driver.

19. The method of claim 14 wherein the first axis is reoriented by rotating the rotating the support.
